(19) United States
(12) Patent Application Publication
(10) Pub. No.: US 2024/0224245 A1
(43) Pub. Date: Jul. 4, 2024

(54) COMMUNICATION METHOD FOR A WIRELESS AD HOC NETWORK, AND WIRELESS AD HOC NETWORK

(71) Applicant: Rohde & Schwarz GmbH & Co. KG, Muenchen (DE)

(72) Inventor: Andreas BAESSLER, Muenchen (DE)

(21) Appl. No.: 18/524,344

(22) Filed: Nov. 30, 2023

(30) Foreign Application Priority Data
Dec. 30, 2022 (EP) 22 217 387.4

(51) Int. Cl. H04W 72/0446; H04B 7/26

(52) U.S. Cl. CPC H04W 72/0446; H04B 7/2643; H04W 84/18

(57) ABSTRACT

A communication method is disclosed for a wireless ad hoc network having a plurality of nodes, each node including a RX circuit and a TX circuit configured to receive or transmit data packages based on time division multiple access (TDMA) frames, respectively. The TDMA frames include time slots that are unambiguously assigned to one of the nodes, respectively. The communication method includes: transmitting, by at least one node of the plurality of nodes, at least one data package in a subset of time slots of a TDMA frame, respectively, wherein the subset of time slots is assigned to a subset of nodes of the plurality of nodes; and deactivating, by the at least one node, the RX circuit and/or the TX circuit of the at least one node during the subset of time slots of subsequent TDMA frames.

### FIELD OF THE DISCLOSURE

Embodiments of the present disclosure generally relate to a communication method for a wireless ad hoc network. Embodiments of the present disclosure further relate to a wireless ad hoc network.

### BACKGROUND

In the state of the art, mobile or wireless networks such as mobile ad hoc networks (MANET) are known that comprise several nodes that communicate with each other. These networks typically comprise several nodes or participants that communicate with each other in order to exchange data packets. The data packets are exchanged between the nodes that all have a dedicated address. This ensures that the communication among these nodes is structured since each node has its own address. However, the addressing is complicated since mobile ad-hoc networks are dynamic in nature, which means that the nodes will enter or leave the network randomly so that (re-)addressing of the nodes is required.

In a plurality of applications of such MANETs, the individual nodes are battery-powered electronic devices. Accordingly, it is desirable to reduce the energy required to maintain the communication between the nodes of the MANET.

Thus, there is a need for a communication method for a wireless ad hoc network, as well as a wireless ad hoc network that are more energy-efficient.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide a communication method for a wireless ad hoc network. The wireless ad hoc network may comprise, for example, a plurality of nodes. The wireless ad hoc network may be, for example, a time-slotted barrage relay network, wherein each node comprises an RX circuit being configured to receive data packages based on time division multiple access (TDMA) frames. Each node may also comprise a TX circuit being configured to transmit data packages based on TDMA frames. The TDMA frames comprise time slots that are unambiguously assigned to one of the nodes, respectively. In an embodiment, the communication method comprises: transmitting, by at least one node of the plurality of nodes, at least one data package in a subset of time slots of a TDMA frame, respectively, wherein the subset of time slots is assigned to a subset of nodes of the plurality of nodes; and deactivating, by the at least one node, the RX circuit and/or the TX circuit of the at least one node during the subset of time slots of subsequent TDMA frames.

As used herein, the term “subset of nodes” is understood to denote one node of the plurality of nodes, two or more nodes of the plurality of nodes, or all nodes of the plurality of nodes. Likewise, the term “subset of time slots” is understood to denote one time slot of the respective TDMA frame, two or more time slots of the respective TDMA frame, or all time slots of the respective TDMA frame. Further, the term “unambiguously assigned” is understood to denote that no time slot is assigned to more than one node. In some embodiments, there is a one-to-one correspondence between the time slots and the nodes.

Accordingly, the at least one node of the plurality of nodes transmitting the at least one data package is part of the subset of nodes to which the subset of time slots is assigned.

In general, the plurality of nodes exchange signals periodically, for example in cycles having a predetermined number of TDMA frames. In the course of each cycle, the at least one node receives and/or transmits the at least one data package during each time slot only once. Accordingly, the RX circuit and/or the TX circuit can be deactivated in time slots in which the at least one data package has already been transmitted by the at least one node for the remaining cycle without risking data loss, as no transmission takes place in these time slots during the remaining cycle.

Thus, the time during which the RX circuit and/or the TX circuit of the at least one node, for example of all nodes, has to be powered within each cycle is reduced significantly, thereby enhancing the energy-efficiency of the wireless ad hoc network.

In some embodiments, the nodes may comprise at least one antenna, respectively, wherein the at least one antenna is coupled with the RX circuit and the TX circuit for receiving and transmitting data packages, respectively. Of course, the nodes may each comprise at least one dedicated RX antenna being coupled with the RX circuit for receiving data packages, and/or at least one dedicated TX antenna being coupled with the TX circuit for transmitting data packages. In some embodiments, the RX circuit and the TX circuit are implemented as a transceiver having one or more antennas.

According to an aspect of the present disclosure, management data, for example, is provided and processed in the time slots assigned to the subset of nodes, respectively. In some embodiments, the management data comprises a remaining hop count portion. The remaining hop count portion comprises information on a remaining hop count for the management data associated with the respective node, wherein a value of the remaining hop count is decreased at each hop by the respective node. For example, the value of the remaining hop count is decreased by one at each hop. If the remaining hop count reaches a predefined value, for example zero, the respective package is not forwarded to any further nodes. The remaining hop count can be transmitted efficiently, as the corresponding sequence of the transmitted data package usually only has to be a few bits long, e.g. 2, 3, or 4 bits.

In some embodiments, the management data may comprise further information that is relevant for configuring the wireless ad hoc network.

According to another aspect of the present disclosure, the RX circuit and/or the TX circuit are, for example, reactivated for the subset of time slots after a number of TDMA frames corresponding to the remaining hop count have elapsed. Therein, the current TDMA frame is taken into account, i.e. the RX circuit and/or the TX circuit are reactivated for the subset of time slots after a number of subsequent TDMA frames corresponding to the remaining hop count minus 1 have elapsed. In other words, the RX circuit and/or the TX circuit are reactivated during the next cycle of frames, thereby ensuring that no data is lost within the wireless ad hoc network.

A further aspect of the present disclosure provides that the subset of nodes comprises, for example, the at least one node and/or nodes being arranged upstream of the at least one node. As used herein, the term “nodes being arranged upstream” is understood to denote nodes from which the at least one node has received at least one data package.

Accordingly, the RX circuit and/or the TX circuit are deactivated during time slots that are assigned to certain nodes, namely nodes whose data packages have already been forwarded by the at least one node.

In another embodiment of the present disclosure, management data is provided and processed in the time slots assigned to the subset of nodes, respectively. The management data comprises, for example, configuration information and/or location information associated with the respective node. In some embodiments, the data packages transmitted by the plurality of nodes within the time slots assigned to the subset of nodes comprise the management data.

In some embodiments, the configuration information and/or the location information associated with the respective node may be transmitted together with the remaining hop count portion described above.

According to another aspect of the present disclosure, the at least one node, for example, transmits data packages received from different other nodes during a single TDMA frames in the subsequent TDMA frame. This way, data packages received from different nodes can be forwarded efficiently during the subsequent TDMA frame.

For example, the at least one node may receive a first data package from a first node during a first time slot of a TDMA frame and a second data package from a second node during a second time slot of the TDMA frame. In the next TDMA frame, the at least one node may forward the first data package during the first time slot and the second data package during the second time slot.

In some embodiments, the TDMA frames may comprise data transmission time slots for transmitting payload data, respectively. In general, the payload data corresponds to data to be exchanged between the nodes other than the management data mentioned above. In other words, the payload data relates to content-related data rather than to data used for configuring the wireless ad hoc network.

In some embodiments, the payload data corresponds to image data, video data, audio data, and/or language data. However, it is to be understood that the payload data may be any other type of data to be exchanged between the plurality of nodes of the wireless ad hoc network.

Embodiments of the present disclosure further provide a wireless ad hoc network. The wireless ad hoc network comprises, for example, a plurality of nodes, wherein the wireless ad hoc network is, for example, a time-slotted barrage relay network. Each node comprises, for example, an RX circuit being configured to receive data packages being based on time division multiple access (TDMA) frames. Each node may also comprise a TX circuit being configured to transmit data packages being based on TDMA frames. The TDMA frames comprise time slots that are unambiguously assigned to one of the nodes, respectively. The wireless ad hoc network is configured to perform the communication method according to any one of the embodiments described above.

Regarding the further advantages and properties of the wireless ad hoc network, reference is made to the explanations given above with respect to the communication method, which also hold for the wireless ad hoc network and vice versa.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a wireless ad hoc network according to an embodiment of the present disclosure;

FIG. 2 schematically shows a node of the wireless ad hoc network of FIG. 1 in more detail;

FIG. 3 shows an example flow chart of a communication method according to an embodiment of the present disclosure;

FIG. 4 schematically shows the general structure of frames transmitted by nodes of the wireless ad hoc network of FIG. 1;

FIG. 5 schematically shows a configuration of a first node and of a second node after a first package has been transmitted initially;

FIG. 6 shows a configuration of the first node and of the second node after the data package has been forwarded; and

FIG. 7 schematically shows the structure of data packages transmitted by the nodes of the wireless ad hoc network of FIG. 1.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

Similarly, any steps described herein may be interchangeable with other steps, or combinations of steps, in order to achieve the same or substantially similar result. Moreover, some of the method steps can be carried serially or in parallel, or in any order unless specifically expressed or understood in the context of other method steps.

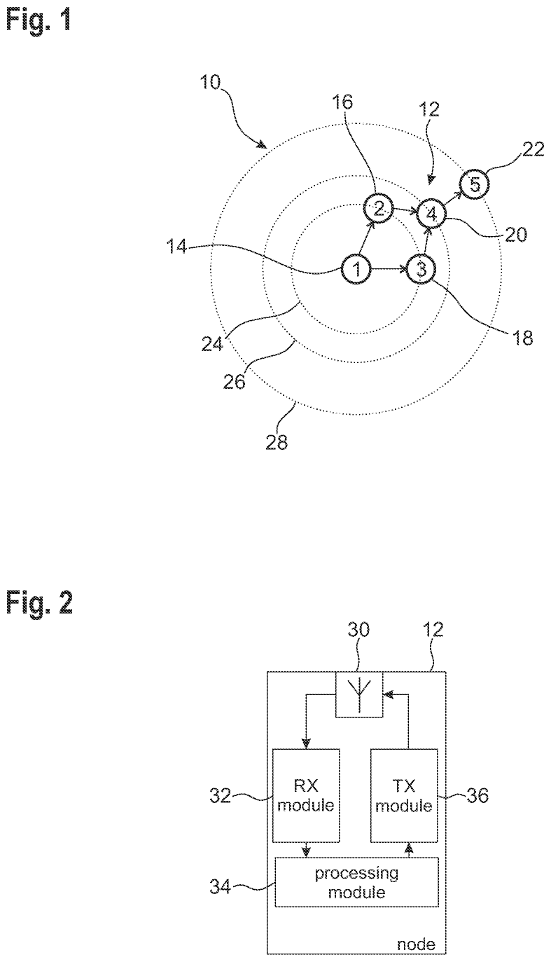

FIG. 1 schematically shows an example of a wireless ad hoc network 10 according to an embodiment of the present disclosure. As shown in FIG. 1, the network 10 comprises a plurality of nodes 12, wherein the wireless ad hoc network 10 is established as a time-slotted barrage relay network.

In general, the nodes 12 are configured to communicate with each other by a wireless communication technique, for example, by a time-division multiple access (TDMA) technique. The individual nodes 12 may be established as any electronic device being capable of TDMA communication, respectively. For example, the nodes 12 may be established as a smart phone, as a handheld radio, as a stationary radio, as a laptop, as a desktop computer, or as any other suitable type of smart device, respectively.

In FIG. 1, the wireless ad hoc network 10 is shown from the viewpoint of a first node 14 of the plurality of nodes 12. It is to be understood that this is for illustration purposes only, i.e. the wireless ad hoc network 10 may likewise be described from the viewpoint of any other node 12.

In the example embodiment shown in FIG. 1, the first node 14 comprises two 1-hop neighbors, namely a second node 16 and a third node 18. The first node 14 further comprises one 2-hop neighbor, namely a fourth node 20, and one 3-hop neighbor, namely a fifth node 22. It is to be understood that the first node 14 may comprise an arbitrary number of 1-hop neighbors 24, 2-hop neighbors 26, 3-hop neighbors 28, etc., as is indicated by the dotted circles in FIG. 1.

FIG. 2 schematically shows one of the nodes 12 in more detail. The node 12 comprises at least one antenna 30 that is configured to receive wireless radio frequency (RF) signals transmitted by the other nodes 12.

The node 12 also comprises an RX circuit 32 that is coupled with the at least one antenna 30 so as to receive the RF signals received by the at least one antenna 30. The RX circuit 32 may be configured to down-convert the received RF signals to an intermediate frequency suitable for processing by a processing circuit 34 that is provided downstream of the RX circuit 32.

In some embodiments, the processing circuit 34 is configured to process data packages comprised in the RF signals received from the other nodes 12. Further, the processing circuit 34 is configured to generate data packages to be transmitted to the other nodes 12 via a TX circuit 36.

In the embodiment shown, the TX circuit 36 is provided downstream of the processing circuit 34. The TX circuit 36 is configured to up-convert signals received from the processing circuit 34 to an RF signal that can be transmitted by the at least one antenna 30, wherein the signals received from the processing circuit 34 comprise the data packages to be transmitted.

It is noted that the node 12 may each comprise at least one dedicated RX antenna being coupled with the RX circuit 32 for receiving data packages, and/or at least one dedicated TX antenna being coupled with the TX circuit 36 for transmitting data packages. In some embodiments, the TX circuit and the RX circuit are implemented as a transceiver having one or more antennas.

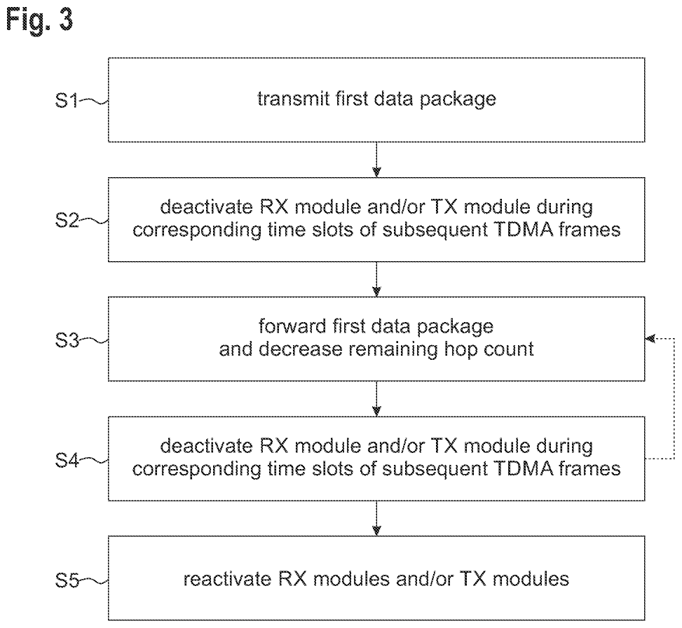

The wireless ad hoc network 10 is configured to perform a communication method, an example of which is described in the following with reference to FIG. 3.

It is noted that the communication method is described hereinafter with respect to data packages transmitted and received by the first node 14, the second node 16, the third node 18, the fourth node 20, and the fifth node 22. It is to be understood that the communication method likewise applies to an arbitrary other number of nodes 12 as well as to an arbitrary other topology of the wireless ad hoc network 10.

A first data package is transmitted by a subset of the plurality of nodes 12, respectively, wherein the first data package is transmitted in a first TDMA frame of a cycle having a predetermined number of TDMA frames (step S1).

In some embodiments, the first data package is transmitted by each node 12 of the plurality of nodes 12, respectively. Without restriction of generality, this case is described hereinafter.

In some embodiments, each node 12 may transmit the first data package to the respective 1-hop neighbors. In general, a subset of time slots of the first TDMA frame (and also of subsequent TDMA frames) is unambiguously assigned to the subset of the plurality of nodes 12. Therein, each node 12 transmits the first data package in a time slot being unambiguously assigned to the respective node 12.

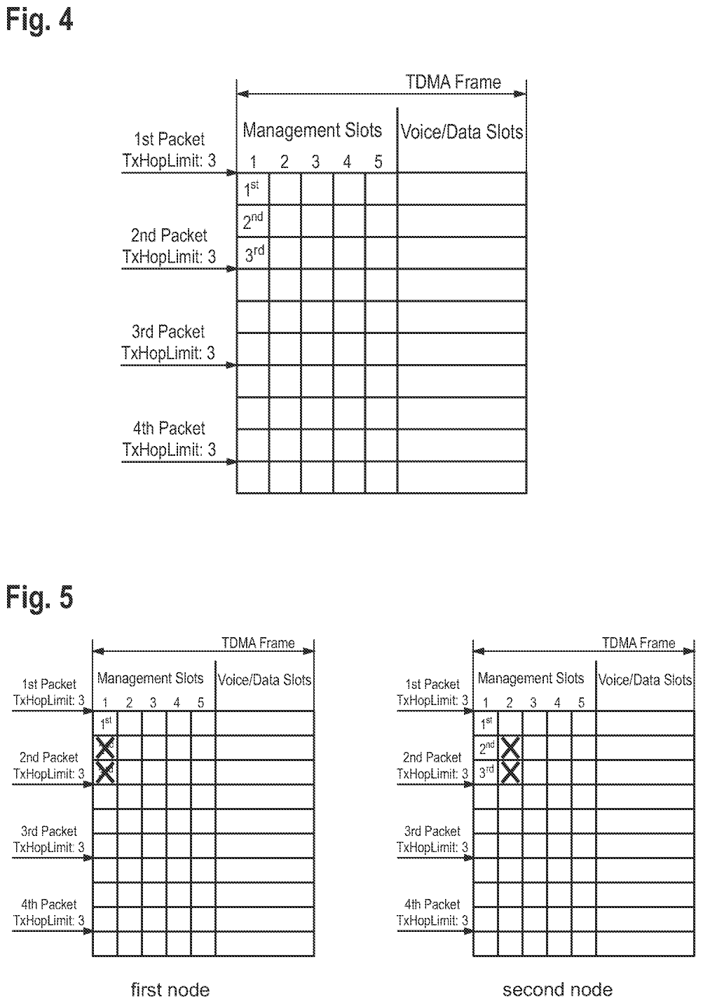

This is further illustrated in FIG. 4, which shows TDMA frames that are used for transmitting the data packages between the nodes 12 of the wireless ad hoc network 10. The time slots being unambiguously assigned to the nodes 12 are denoted as “Management Slots” in FIG. 4.

The TDMA frames may further comprise data transmission time slots for transmitting payload data (“Voice/Data Slots” in FIG. 4). In general, the payload data may correspond to image data, video data, audio data, language data, and/or arbitrary other types of data.

In the example shown in FIG. 4, the first time slot is assigned to the first node 14, such that all data packages associated with the first node 14 are transmitted during the first “Management Slot”. Further, the second time slot is assigned to the second node 16, etc.

In some embodiments, during the first time slot of the first TDMA frame (“1 st” in FIG. 4), the first node 14 transmits at least one first data package to the second node 16 and to the third node 18, respectively.

During the second time slot of the first TDMA frame, the second node 16 may transmit at least one first data package to the first node 14 and to the fourth node 20, respectively. In some embodiments, the second node 16 may transmit at least one first data package to the third node 18 if the third node 18 is a 1-hop neighbor of the second node 16.

The third node 18, the fourth node 20, and the fifth node 22 likewise transmit the at least one first data package to their respective 1-hop neighbors during the respectively assigned time slot.

The nodes 12 each deactivate the RX circuit 32 and/or the TX circuit 36 during their respectively assigned time slot of subsequent TDMA frames (step S2).

In some embodiments, both the RX circuit 32 and the TX circuit 36 are deactivated. Without restriction of generality, this case is described in the following.

This is illustrated in FIG. 5, which shows that the first node 14 has deactivated the RX circuit 32 and the TX circuit 36 during the first time slot of the second frame and during the first time slot of the third frame, respectively, as is indicated by the crossed-out time slots in FIG. 5. Likewise, the second node 16 has deactivated the RX circuit 32 and the TX circuit 36 during the second time slot of the second frame and during the second time slot of the third frame, respectively, etc.

The respectively received at least one first data package is forwarded by the nodes 12 (step S3). For example, during the first time slot of the second TDMA frame (“2nd” in FIG. 3), the second node 16 and the third node 18 forward the at least one first data package received from the first node 14 to the fourth node 20, respectively.

In the example topology of the wireless ad hoc network 10 shown in FIG. 1, the first node 14 may not forward the at least one first data package received from the second node 16 and the at least one data package received from the node 18 any further, as there are no nodes to forward the at least one first data package to.

If a node 12 has received at least one first data package from several nodes, respectively, the node 12 may transmit all first data packages received in the first TDMA frame during the second TDMA frame. In the example topology of the wireless ad hoc network 10 shown in FIG. 1, this applies to the fourth node 20.

During the first TDMA frame, the fourth node 20 has received the at least one first data package from the second node 16 and from the third node 18, respectively. Thus, the fourth node 20 may forward the at least one first data package received from the second node 16 to the fifth node 22 during the second time slot of the second TDMA frame. Further, the fourth node 20 may forward the at least one first data package received from the third node 18 to the fifth node 22 during the third time slot of the second TDMA frame.

The nodes 12 respectively deactivate the RX circuit 32 and/or the TX circuit 36 during the time slots used for forwarding the at least one first data package (step S4).

In some embodiments, both the RX circuit 32 and the TX circuit 36 are deactivated. Without restriction of generality, this case is described in the following.

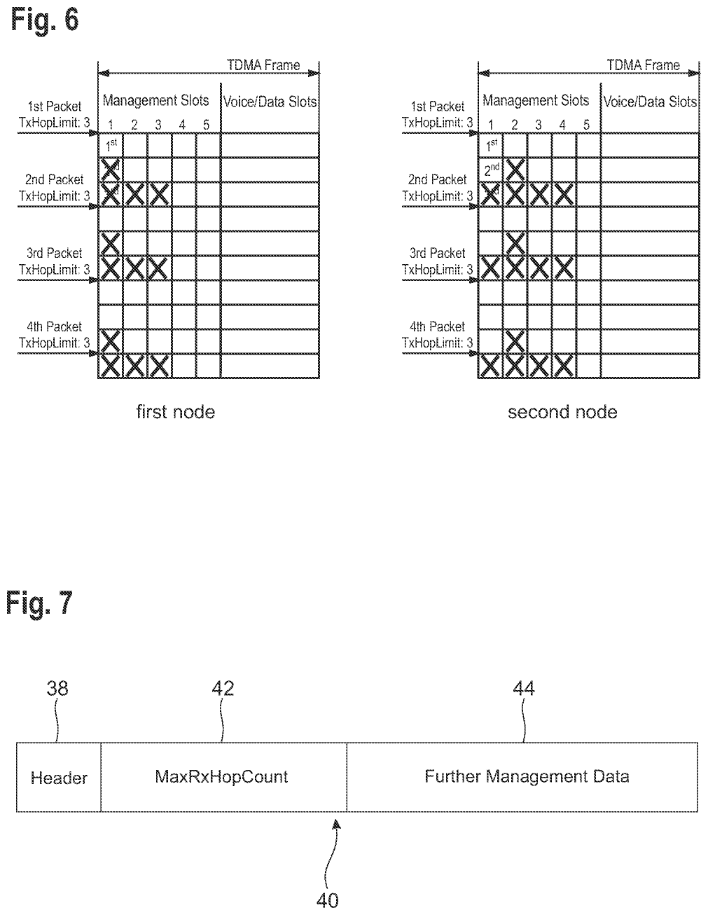

This is illustrated in FIG. 6, which shows that the first node 14 has deactivated the RX circuit 32 and the TX circuit 36 during the second time slot of the third frame and during the third time slot of the third frame, respectively. This is done since the first node 14 does not have to forward the at least one first data package associated with the second node 16 and with the third node 18 anymore. Likewise, the second node 16 (assuming that the second node has received the at least one data package form the first node 14, the third node 18, and the fourth node 20) has deactivated the RX circuit 32 and the TX circuit 36 during the first time slot of the third frame, during the third timeslot of the third frame, and during the fourth time slot of the third frame, respectively.

As is indicated by the dashed arrow in FIG. 3, the steps of forwarding the at least one first data package and deactivating the RX circuits 32 and/or the TX circuits 36 are repeated for a predetermined number of TDMA frames, namely until the end of the first cycle of TDMA frames.

In the example embodiment shown in FIGS. 1 and 4-6, each cycle comprises three TDMA frames, i.e. the data packages transmitted by the nodes 12 are allowed to hop a maximum number of three times. This may, of course, vary depending on the topology of the wireless ad hoc network 10.

In order to determine the number of frames for which the RX circuit 32 and/or the TX circuit 36 can be safely deactivated without missing any communication, the data packages transmitted by the nodes 12 may comprise additional information with respect to the remaining hop count of the respective data package.

FIG. 7 schematically shows an example structure of a data package. The data package comprises a header 38, and a management data portion 40, wherein the management data portion 40 comprises a remaining hop count portion 42, and a further management data portion 42. It is noted that the data package may comprise further portions comprising further information.

The header 38 may be configured as in usual wireless ad hoc networks. For example, the header 38 may comprise the address of a target node 12 for the respective data package. The management data portion 42 comprises further management data associated with the respective node 12, e.g. configuration information and/or location information associated with the respective node 12. The remaining hop count portion 42 comprises information on a remaining hop count of the respective data package.

When the first node 14 transmits the at least one first data package, the value of the remaining hop count portion 42 is equal to the maximum allowable hops in the current configuration of the wireless ad hoc network 10. Accordingly, the remaining hop count portion 42 of the at least one first data package transmitted by the first node 14 comprises the information “remaining hop count=3”.

The value of the remaining hop count is decreased by one at each hop by the respective node 12.

Thus, the second node 16 reduces the value of the remaining hop count to two, i.e. the remaining hop count portion 42 of the at least one first data package associated with the first node 14 and forwarded by the second node 16 comprises the information “remaining hop count=2”.

If the remaining hop count reaches a predefined value, for example zero, the respective package is not forwarded to any further nodes.

Each node 12 may deactivate the RX circuit 32 and/or the TX circuit 36 for a number of subsequent frames corresponding to the remaining hop count of the respective data package minus one, which corresponds to the remaining number of frames within the respective cycle.

After the number of frames has elapsed, the RX circuit 32 and/or the TX circuit are reactivated (step S5).

As is illustrated in FIG. 6, the previously deactivated RX circuits 32 and/or TX circuits 36 are reactivated for the first TDMA frame of the second cycle of TDMA frames. The steps S1 to S5 described above may then be repeated for further data packages transmitted by the nodes 12.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

Certain embodiments disclosed herein include systems, apparatus, modules, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implemented the functionality and/or methodology described herein.

In some embodiments, one or more of the components, such as the nodes, RX and/or TX circuits, etc., of the network referenced above include circuitry programmed to carry out one or more steps of any of the methods disclosed herein. In some embodiments, one or more computer-readable media associated with or accessible by such circuitry contains computer readable instructions embodied thereon that, when executed by such circuitry, cause the component or circuitry to perform one or more steps of any of the methods disclosed herein.

In some embodiments, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In some embodiments, computer-readable media is any medium that stores computer readable instructions, or other information non-transitorily and is directly or indirectly accessible to a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In some embodiments, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

In the detailed description herein, references to “one embodiment”, “an embodiment”, “an example embodiment”, “some embodiments”, etc., indicate that the embodiment(s) described may include a particular feature, structure, or characteristic, but every embodiment may not necessarily include the particular feature, structure, or characteristic. Moreover, such phrases are not necessarily referring to the same embodiment(s). In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

The present application may reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value.

For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A communication method for a wireless ad hoc network, wherein the wireless ad hoc network comprises a plurality of nodes, wherein the wireless ad hoc network is a time-slotted barrage relay network, wherein each node comprises an RX circuit being configured to receive data packages based on time division multiple access (TDMA) frames, wherein each node comprises a TX circuit being configured to transmit data packages based on TDMA frames, and wherein the TDMA frames comprise time slots that are unambiguously assigned to one of the nodes, respectively, the communication method comprising the steps of
transmitting, by at least one node of the plurality of nodes, at least one data package in a subset of time slots of a TDMA frame, respectively, wherein the subset of time slots is assigned to a subset of nodes of the plurality of nodes; and
deactivating, by the at least one node, the RX circuit and/or the TX circuit of the at least one node during the subset of time slots of subsequent TDMA frames.

2. The communication method of claim 1, wherein management data is provided and processed in the time slots assigned to the subset of nodes, respectively, wherein the management data comprises a remaining hop count portion, wherein the remaining hop count portion comprises information on a remaining hop count for the management data associated with the respective node, and wherein a value of the remaining hop count is decreased at each hop by the respective node.

3. The communication method of claim 2, wherein the RX circuit and/or the TX circuit are reactivated for the subset of time slots after a number of TDMA frames corresponding to the remaining hop count have elapsed.

4. The communication method according to claim 1, wherein the subset of nodes comprises the at least one node and/or nodes being arranged upstream of the at least one node.

5. The communication method according to claim 1, wherein management data is provided and processed in the time slots assigned to the subset of nodes, respectively, wherein the management data comprises configuration information and/or location information associated with the respective node.

6. The communication method according to claim 1, wherein the at least one node transmits data packages received from different other nodes during a single TDMA frame in the subsequent TDMA frame.

7. The communication method according to claim 1, wherein the TDMA frames comprise data transmission time slots for transmitting payload data, respectively.

8. The communication method of claim 7, wherein the payload data corresponds to image data, video data, audio data, and/or language data.

9. A wireless ad hoc network, wherein the wireless ad hoc network comprises a plurality of nodes, wherein the wireless ad hoc network is a time-slotted barrage relay network, wherein each node comprises an RX circuit being configured to receive data packages based on time division multiple access (TDMA) frames, wherein each node comprises a TX circuit being configured to transmit data packages based on TDMA frames, wherein the TDMA frames comprise time slots that are unambiguously assigned to one of the nodes, respectively, and wherein the wireless ad hoc network is configured to perform the communication method according to claim 1.
